(19) United States
(12) Patent Application Publication
(10) Pub. No.: US 2011/0023546 A1
(43) Pub. Date: Feb. 3, 2011

(54) LOWER MOLDING DIE, METHOD FOR MANUFACTURING LOWER MOLDING DIE, METHOD FOR MANUFACTURING GLASS GOB, AND METHOD FOR MANUFACTURING GLASS MOLDED ARTICLE

(75) Inventors: Shunichi Hayamizu, Hyogo (JP); Naoyuki Fukumoto, Hyogo (JP); Kento Hasegawa, Osaka (JP)

Correspondence Address: BRINKS HOFER GILSON & LIONE, P.O. BOX 10395, CHICAGO, IL, 60610, US

(73) Assignee: Konica Minolta Opto, Inc,, Tokyo (JP)

(21) Appl. No.: 12/935,213

(22) PCT Filed: Mar. 24, 2009
(86) PCT No.: PCT/JP2009/055734

§ 371 Date: Sep. 28, 2010

(30) Foreign Application Priority Data
Apr. 3, 2008 (JP) 2008096970

(51) Int. Cl. C03B 11/08; C03B 11/06; B05D 5/02

(52) U.S. Cl. 65/83; 65/302; 65/66; 427/331

(57) ABSTRACT

Disclosed is a lower molding die for receiving a molten glass droplet which is dripped. A cover layer is formed on a substrate with an intermediate layer therebetween, and a roughening process is performed on the surface of the cover layer in order to increase arithmetic average roughness Ra. The surface of the cover layer subjected to the roughening process has an arithmetic average roughness Ra of 0.01 μm or more, and an average length RSm of a roughness curvilinear element of 0.5 μm or less.

### TECHNICAL FIELD

The present invention relates to a lower molding die for receiving a molten glass droplet which is dropped, a method for manufacturing the lower molding die, a method for manufacturing a glass gob using the lower molding die, and a method for manufacturing a glass molded article using the lower molding die.

### BACKGROUND ART

In recent years, optical elements made of glass are used in a wide range of applications such as lenses for digital cameras, optical pickup lenses for DVDs and the like, camera lenses for cell phones and coupling lenses in optical communications. As such an optical element made of glass, a molded glass article manufactured by press-molding of glass material by use of a molding die is generally used.

As a method for producing a molded glass article by press-molding, two methods, or a reheat press method and a liquid drop molding method, are known. A reheat press method is a method in which a glass preform (a preliminary molded article) having a predetermined mass and form prepared in advance is subjected to press-molding by being heated together with a molding die, and is widely practiced because it requires no facilities such as a glass furnace.

As a glass preform used in a reheat press method, conventionally, those manufactured by means of mechanical processing such as cutting and grinding (ground preforms) are generally used; however, there was a problem of requiring much labor and time in manufacturing a ground preform. Therefore, a study of a method, in which a glass gob is prepared by cooling solidification of a molten glass droplet dropped on a lower molding die and the prepared glass gob is used as a glass preform for a reheat press method (a gob preform), is in progress.

On the other hand, a liquid drop molding method is a method in which a molten glass droplet is dropped on a lower molding die heated at a predetermined temperature and the molten glass droplet dropped is subjected to press-molding by use of the lower molding die and an upper molding die to prepare a glass molded article. This method is noted because a glass molded article can be manufactured directly from a molten glass droplet without repeated heating and cooling of a lower molding die and an upper molding die and time required for one molding can be made very short.

However, when a molten glass droplet is dropped on a lower molding die for manufacturing a glass gob or for manufacturing a glass molded article by a liquid molding method, a minute concave part is formed in the central neighborhood of the bottom surface of a molten glass droplet (the contact surface with a lower molding die) due to a shock at the time of collision. Since air getting in the concave part has no escaping route, it is kept sealed until a molten glass droplet is cool-solidified, and there is a problem of the concave part (air bubble) were remained on the bottom surface of a glass gob or a glass molded article manufactured.

To solve this problem, proposed is a method in which the surface of a lower molding die is roughened so as to make Rmax in a range of 0.05-0.2 μm and secure a flow path of air having got in the concave part thereby preventing the air bubble from remaining (for example, refer to patent document 1).

Further, proposed is a lower molding die which prevents an air bubble as well as makes easy reproduction by forming a cover layer on the surface of an under layer having been roughened so as to make Rmax in a range of 0.005-0.05 μm (for example, refer to patent document 2).

Patent document 1: Japanese Laid-Open Patent Application Publication No. H03-137031
Patent document 2: Japanese Laid-Open Patent Application Publication No. 2005-272187

### DISCLOSURE OF THE INVENTION

### Object of the Invention

For prevention of an air bubble according to methods described in patent documents 1 and 2, it is necessary to provide the surface of a lower molding die with roughening by etching and the like so as to have a predetermined surface roughness.

Generally, there are various limiting conditions with respect to a material used for a lower molding die and an upper molding die which contact with a molten glass droplet, and the material should satisfy many conditions such as being hardly react with glass at high temperature, being able to have a mirror surface, being excellent in processing capabilities, being hard and not being fragile. Few materials satisfy these various conditions, and for example, super hard materials comprising tungsten carbide as a primary component, ceramic materials such as silicon carbide, silicon nitride and aluminum nitride, and complex materials containing carbon are preferably used.

However, as for these materials, it is difficult in many cases to uniformly roughen the surface to provide a predetermined surface roughness by general wet etching or dry etching. Further, as in the case of a super hard material comprising tungsten carbide as a primary component, some materials are possible to be roughened by means of etching; however, the surface having been roughened becomes very fragile resulting in very poor durability.

As a result, in the case of using these materials in a lower molding die, it is impossible to prepare a lower molding die as described in patent documents 1 and 2 for manufacturing a glass gob or a glass molded article without an air bubble, and a manufacture cost of a glass gob or a glass molded article is very expensive due to poor durability of a prepared lower molding die; which are problematic.

This invention has been conceived in view of the above-described problems, and an object of this invention is to provide a lower molding die in which an air bubble can be effectively prevented from being generated and durability is excellent, and to provide a method for manufacturing the lower molding die, as well as to provide a method for manufacturing a glass gob and a glass molded article using the lower molding die.

### Means for Solving the Object

In order to solve the above problems, the present invention includes the following features.

1. A lower molding die for receiving a dropped molten glass droplet, the lower molding die comprising:

a substrate;

an intermediate layer formed on the substrate; and

a cover layer formed on the intermediate layer,

wherein a surface of the cover layer has been subjected to a roughening process for increasing an arithmetic average roughness Ra, and the surface of the cover layer has the arithmetic average roughness Ra of 0.01 μm or more and an average length RSm of a roughness curvilinear element of 0.5 μm or less.

2. The lower molding die of item 1, wherein the surface of the cover layer has an arithmetic average roughness Ra of 0.2 μm or less.

3. The lower molding die of item 1 or 2, wherein the intermediate layer includes at least one of metallic titanium, titanium carbide and titanium nitride.

4. The lower molding die of any one of items 1 to 3, wherein the intermediate layer has a thickness of 0.03 μm or more and 2 μm or less.

5. A method for manufacturing a lower molding die for receiving a dropped molten glass droplet, the method comprising the steps of:

forming an intermediate layer on a substrate;

forming a cover layer on the intermediate layer;

performing a roughening process on a surface of the cover layer to increase an arithmetic average roughness Ra,

wherein the surface of the cover layer having been subjected to the roughening process has an arithmetic average roughness Ra of 0.01 μm or more and an average length RSm of a roughness curvilinear element of 0.05 μm or less.

6. A method for manufacturing a glass gob, the method comprising the steps of:

dropping a molten glass droplet on a lower molding die; and

cool-solidifying the dropped molten glass droplet on the lower molding die,

wherein the lower molding die is a molding die of any one of items 1 to 4.

7. A method for manufacturing a glass molded article, the method comprising the steps of:

dropping a molten glass droplet on a lower molding die; and

press-molding the dropped molten glass droplet with the lower molding die and an upper molding die facing the lower molding die,

wherein the lower molding die is a lower molding die of any one of items 1 to 4.

8. The method of item 7 for manufacturing a glass molded article, wherein the upper molding die includes:

a substrate;

an intermediate layer formed on the substrate; and

a cover layer formed on the intermediate layer,

wherein a surface of the cover layer has been subjected to a roughening process for increasing an arithmetic average roughness Ra.

9. The method of item 8 for manufacturing a glass molded article, wherein the surface of the cover layer of the upper molding die has an arithmetic average roughness Ra of 0.01 μm or more and 0.2 μm or less.

### ADVANTAGE OF THE INVENTION

Since a surface of cover layer of a lower molding die of the present invention is made to have a predetermined surface state by a roughening process, a flow path for air contained in a depression is secured so as to effectively prevent the occurrence of a air bubble. In addition, an intermediate layer formed between a substrate and the cover layer prevents the deterioration of the substrate due to the roughening process, and the lower molding die is excellent in durability.

According to a method for manufacturing a glass gob of the present invention, the glass gob having no air bubble is manufactured at a low cost by dropping a molten glass droplet on a lower molding die of the present invention. In addition, a glass molded article having no air bubble is manufactured at a low cost by dropping a molten glass droplet on a lower molding die of the present invention and press-molding the dropped molten glass droplet with the lower molding die and an upper molding die.

### BRIEF DESCRIPTION OF THE DRAWINGS

FIG. 1 is a cross-sectional view to schematically show an example of lower molding die 10;

FIGS. 2a and 2b are drawings to show a state of molten glass droplet 20 dropped on lower molding die 10;

FIGS. 3a, 3b, and 3c are schematic drawings to show the detail of A portion of FIG. 2b;

FIG. 4 is a flow chart to show an example of a method for manufacturing a glass gob;

FIG. 5 is a schematic drawing (a cross-sectional view to show a state in step S12) for explanation of a method for manufacturing a glass gob;

FIG. 6 is a schematic drawing (a cross-sectional view to show a state in step S13) for explanation of a method for manufacturing a glass gob;

FIG. 7 is a flow chart to show an example of a method for manufacturing a glass gob;

FIG. 8 is a schematic drawing (a cross-sectional view to show a state in step S23) for explanation of a method for manufacturing a glass molded article; and

FIG. 9 is a schematic drawing (a cross-sectional view to show a state in step S25) for explanation of a method for manufacturing a glass molded article.

### DESCRIPTION OF THE NUMERALS

10: Lower molding die
12: Intermediate layer
13: Substrate
14: Cover layer
15: Surface of the cover layer 14
16: Upper molding die
17: Press surface
20: Molten glass droplet
21: Concave part
23: Gap
24: Molten glass
25: Melting bath
26: Dropping nozzle
27: Glass gob
28: Glass molded article

### BEST MODE FOR CARRYING OUT THE INVENTION

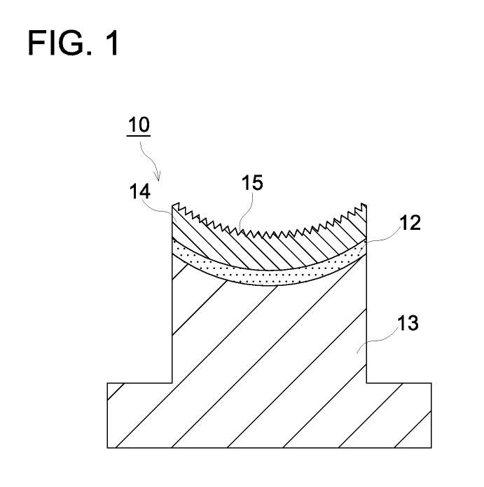

In the following, an embodiment of this invention will be detailed in reference to FIGS. 1-9.

(Lower Molding Die)

FIG. 1 is a cross-sectional view to schematically show an example of a lower molding die of this embodiment. Lower molding die 10 shown in FIG. 1 is provided with a substrate 13, an intermediate layer 12 formed on the substrate 13, and a cover layer 14 formed on the intermediate layer 12. A surface 15 of the cover layer 14 has been subjected to a roughening process to increase arithmetic average roughness Ra.

The lower molding die 10 is manufactured by forming the cover layer 13 on the intermediate layer 12 after forming the intermediate layer 12 on the substrate 13, and by providing the surface 15 of the cover layer 14 having been subjected to a roughening process to increase the arithmetic average roughness Ra.

In this manner, in manufacture of the lower molding die 10, it is not necessary to provide the substrate 13 with a roughening process before deposition of the cover layer 14 because a roughening process will be performed on the cover layer 14 formed. Therefore, a material for the substrate 13 can be selected without paying attention to easiness of roughening and durability in consideration of being roughened. Materials preferably used include, for example, various heat-resistant alloys (such as stainless-steel), super hard materials comprising tungsten carbide as a primary component, various types of ceramics (such as silicon carbide, silicon nitride and aluminum nitride) and complex materials containing carbon.

A material for the cover layer 14 is not specifically limited, and for example, various metals (such as chromium, aluminum and titanium), nitrides (such as chromium nitride, aluminum nitride, titanium nitride and boron nitride) and oxides (such as chromium oxide, aluminum oxide and titanium oxide) can be used.

Among them, a metallic layer made up of at least one of chromium, aluminum and titanium is specifically preferable. Any of chromium, aluminum and titanium has advantages of easy deposition and easy roughening by etching, in addition, are characterized by a stable oxide layer being formed by oxidation of the surface with heating in the atmosphere. Since any oxide of chromium, aluminum and titanium has large advantages of not easily reacting even in contact with a molten glass droplet at a high temperature because of a small standard free energy of formation (standard Gibbs' energy of formation) and large stability.

The thickness of the cover layer 14 may be as thick as to provide a desired surface roughness by a roughening process after deposition and is generally preferably not less than 0.05 μm. On the other hand, there may be a case to easily generate defects such as film peeling when the cover layer 14 is excessively thick. Therefore, the thickness of the cover layer 14 is preferably in a range of not less than 0.05 μm and not more than 5 μm and more preferably in a range of not less than 0.1 μm and not more than 1 μm.

The deposition method of cover layer 14 is not specifically limited and may be appropriately selected among deposition methods well known in the art. For example, listed are vacuum evaporation, spattering and CVD.

The intermediate layer 12 formed between the substrate 13 and the cover layer 14 is provided with a function to prevent substrate 13 from deterioration by influence of an etching solution at the time of performing a roughening process on the cover layer 14. Therefore, comparing to a lower molding die in which the cover layer 14 is directly formed on the substrate 13 without providing intermediate layer and roughened, the lower molding die with intermediate layer 12 hardly causes deterioration (such as film peeling) of the cover layer 14 due to repeated molding and exhibits excellent durability.

Further, in the case that the cover layer 14 has been deteriorated due to long term usage, it is possible to renew the lower molding die 10 by forming a new cover layer 14 after removing the cover layer 14 having been deteriorated. The lower molding die 10 of the embodiment of this invention can restrain deterioration of substrate due to influence of an etching solution at the time of removing the cover layer 14 for the renewing to minimum because the intermediate layer 12 exists between the cover layer 14 and the substrate 13.

The material for the intermediate layer 12 is not specifically limited and materials which hardly deteriorate at the time of a roughening process on the cover layer 14 are preferably used. Among them, the intermediate layer 12 constituted of a material containing at least one type among metallic titanium, titanium carbide and titanium nitride is specifically effective because it has excellent nature to protect the substrate 13 at the time of a roughening process and has an effect to enhance adhesion between the substrate 13 and the cover layer 14. Such materials include, for example, metallic titanium, titanium carbide and titanium nitride and aluminum titanium nitride.

Deposition method of the intermediate layer 12 is not limited either, and may be appropriately selected among deposition methods well known in the art. For example, listed are vacuum evaporation, spattering and CVD. Generally, when intermediate layer 12 is excessively thin, the substrate 13 easily receives damage at the time of a roughening process. On the contrary, when intermediate layer 12 is excessively thick, there may be a case of causing large deformation of an optical plane shape formed on the substrate 13. In this viewpoint, the thickness of the intermediate layer 12 is preferably in a range of not less than 0.03 μm and not more than 2 μm and more preferably in a range of not less than 0.1 μm and not more than 1 μm.

The surface 15 of the cover layer 14 is subjected to a roughening process to increase arithmetic average roughness Ra. Thereby, it is possible to prevent generation of an air bubble in a glass gob or a glass molded article which is prepared by dropping a molten glass droplet on the lower molding die 10.

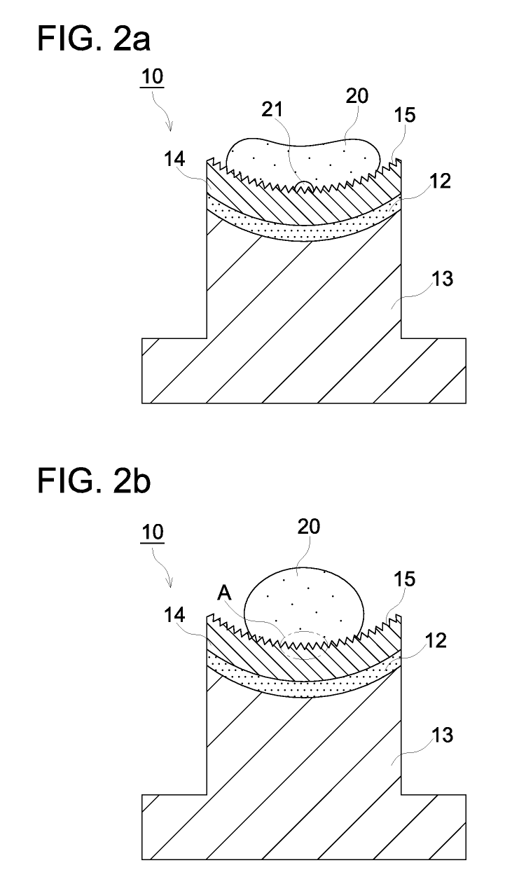

The reason why generation of an air bubble can be prevented by subjecting the surface 15 of the cover layer 14 to a roughening process will now be explained in reference to FIGS. 2a -3c.

FIGS. 2a and 2b a cross-sectional views to show a state of molten glass droplet 20 dropped on the lower molding die 10. FIG. 2a shows a state of the moment when the molten glass droplet 20 collided against the lower molding die 10 and FIG. 2b shows a state of the molten glass droplet 20 having been rounded due to surface tension, thereafter.

As shown in FIG. 2a, the molten glass droplet 20 is extended to be flat by the shock of collision at the moment of having been dropped and collided against the lower molding die 10. At this time, in the molten glass droplet 20, in the central neighborhood of the bottom surface (the surface contacting with the cover layer 14), a concave part 21 having a diameter of approximately as minute as from a few tens pm to a few hundreds μm is formed. The mechanism of generation of the concave part 21 is not necessarily clear, however, according to analysis employing simulation, it is estimated that concave part 21 will be formed because the part of glass firstly colliding against the lower molding die 10 is rebounded upward due to reaction at the time of collision of the molten glass droplet 20 against the lower molding die 10.

Thereafter, the molten glass droplet 20 is deformed to be rounded by an action of surface tension as shown in FIG. 2b. At this time, in the case that the surface 15 of the cover layer 14 is not subjected to a roughening process, since the bottom surface of the molten glass droplet 20 and the cover layer 14 are stick to each other not to allow an escape path for air contained in the concave part 21, the concave part 21 is kept remaining as an air bubble without disappearing. However, when the surface 15 of the cover layer 14 is subjected to a roughening process, a minute gap will remain between the bottom surface of the molten glass droplet 20 and the cover layer 14. Thereby, at the time of the molten glass droplet 20 is deformed to be rounded due to action of surface tension, air contained in the concave part 21 will escape through the gap and the concave part 21 will disappear, whereby generation of an air bubble is prevented.

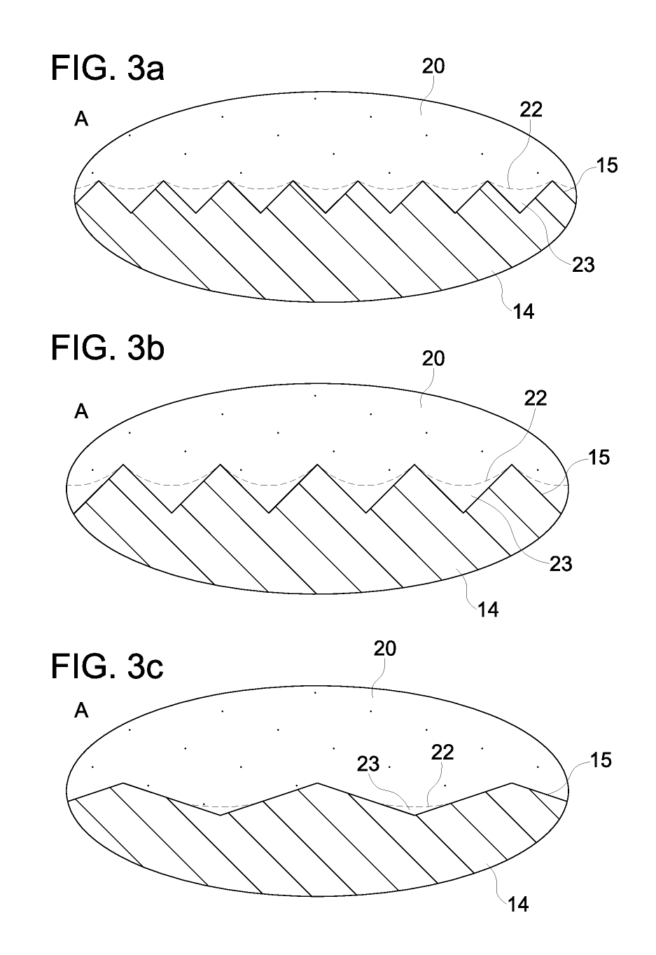

The state of a minute gap generated between the bottom surface of the molten glass droplet 20 and the cover layer 14 will be detailed in reference to FIGS. 3a, 3b, and 3c. FIGS. 3a, 3b, and 3c are schematic drawings to show the details of A portion of FIG. 2b. As shown in FIG. 3a, roughness is formed on the surface 15 of the cover layer 14 by a roughening process. The bottom surface 22 of the molten glass droplet 20 dropped does not get into the bottom parts of roughness of the surface 15 of the cover layer 14, leaving gap 23. This gap 23 becomes an escape path for the air contained in the concave part 21, and the concave part 21 will disappear.

The inventors of this invention have found as a result of extensive study that it is possible to effectively extinguish concave part 21 by using a roughening process to make an arithmetic average roughness Ra of not less than 0.01 μm and an average length RSm of a roughness curvilinear element of not more than 0.5 μm.

Herein, arithmetic average roughness Ra and average length RSm of a roughness curvilinear element are roughness parameters defined in Japanese Industrial Standards B 0601:2001. In this invention, the measurement of these parameters is performed by use of a measuring apparatus having a spatial resolution of not more than 0.1 μm such as an AFM (atomic force microscope). A general stylus roughness meter is not preferred because a radius of curvature of the stylus top is as large as a few μm.

When the height of roughness of the surface 15 is excessively small, glass will get into the considerable portion of the valleys of roughness to make gap 23 to be small, whereby the concave part 21 is not completely extinguished and kept remain. Therefore, arithmetic average roughness Ra is required to be not less than 0.01 μm. On the other hand, when roughness is high as shown in FIG. 3b, the gap 23 having a enough size are formed and concave part 21 is easily extinguished; however, large roughness may be formed on the bottom surface 22 of the molten glass droplet 20 to make the surface roughness of a glass gob or a glass molded article prepared to be excessively large. Therefore, the surface 15 of the cover layer 14 is preferably has an arithmetic average roughness Ra of not more than 0.2 μm.

Further, the period of roughness also affects generation of an air bubble. FIG. 3c shows the case of roughness having a longer period although the height of roughness of surface 15 is equal to that of FIG. 3a. In this manner, when the period is long even with the same height of roughness, glass will get into the bottom of the valleys of roughness to make the gap 23 as an escape path for air to be small. Therefore, an average length RSm of a roughness curvilinear element is required to be not more than 0.5 μm.

By setting the arithmetic average roughness Ra to be not less than 0.01 μm and the average length RSm of a roughness curvilinear element to be not more than 0.5 μm by a roughening process in this manner, it is possible to form a sufficient escape path for air so as to effectively extinguish the concave part 21.

Here, a roughening process is not necessarily performed over the whole surface 15 of the cover layer 14, and at least a region which contacts with the molten glass droplet 20 may be performed with a roughening process.

A roughening process can be performed by etching and the like. A method of etching is not specifically limited, and either wet etching using an etching solution or dry etching using plasma may be employed. As described above, the lower molding die 10 used in this embodiment can effectively prevent deterioration of the substrate 13 due to etching for roughening because intermediate layer 12 is arranged between the substrate 13 and the cover layer 14.

Wet etching is a method to roughen the surface 15 by bringing a reactive etching solution in contact with the cover layer 14, and can easily perform a roughening process without requiring expensive facilities. The cover layer 14 may be immersed in reserved etching solution, or predetermined quantity of etching solution may be supplied on the cover layer 14. Further, a method of spraying etching solution in a spry form can be also employed. An etching solution may be appropriately selected among etching solutions well known in the art.

On the other hand, dry etching using plasma is a method where etching gas is introduced into a vacuum chamber and then generating plasma by high frequency wave and roughening the surface 15 of the cover layer 14 with ions and radials generated by plasma. It may be also referred to as plasma etching or reactive ion etching (RIE). This is a preferable method because of small environmental load due to no generation of effluent, little contamination of the surface with foreign matters, and excellent reproducibility of the process.

As an etching gas, either an inert gas such as Ar or a highly reactive gas containing halogen such as F, Cl and Br may be used. Among them, a reactive gas containing halogen such as F, Cl and Br (for example, CF₄, SF₆, CHF₃, Cl₂, BCl₃ and HBr) has high reactivity with the cover layer 14, thereby shortening the process time. Further, a mixture gas comprising these gases with O₂ and N₂ may be also used. Further, an apparatus for dry etching may be selected among apparatuses well known in the art such as a parallel flat plane type, a barrel (column) type, a magnetron type and an ECR type without limiting thereto.

In this embodiment, the case that each of the cover layer 14 and the intermediate layer 12 is constituted by only one layer was exemplified and explained; however, this invention is not limited thereto. For example, the intermediate layer 12 comprising two layers may be provided under cover layer 14 having been subjected to a roughening process, or a protective layer to protect the surface may be arranged on the cover layer 14 having been subjected to a roughening process.

(Method for Manufacturing Glass Gob)

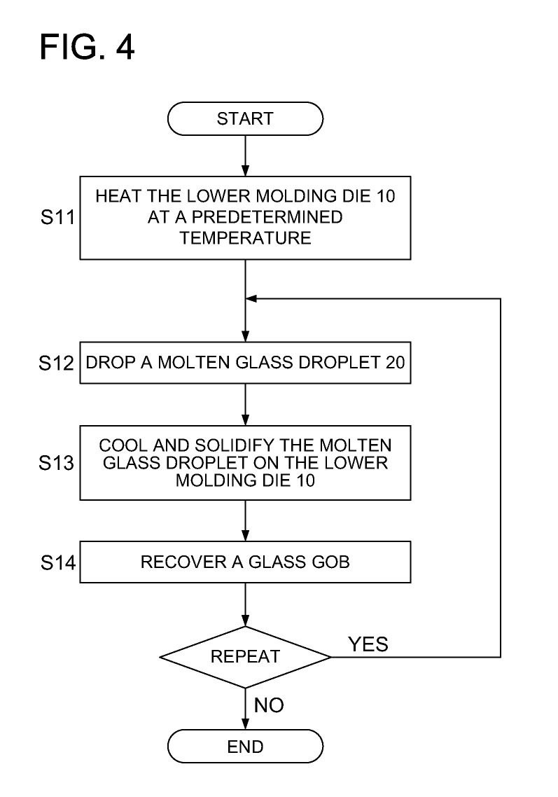

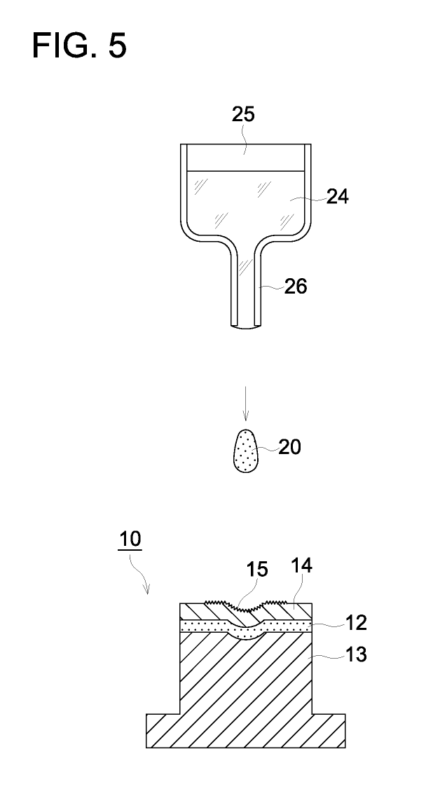

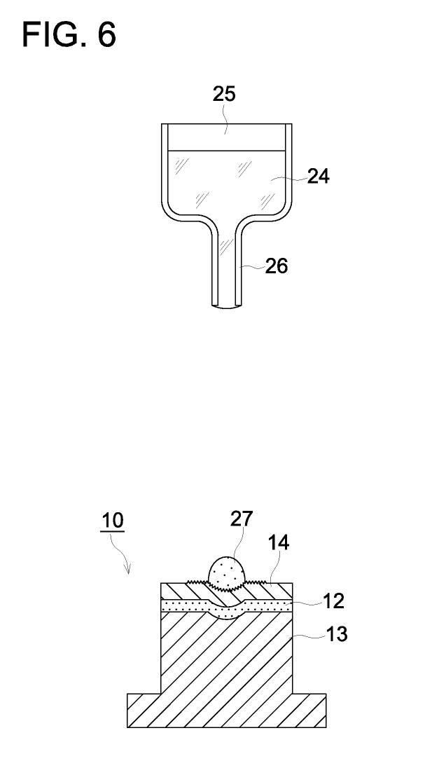

A method for manufacturing a glass gob according to this invention will be explained in reference to FIGS. 4-6. FIG. 4 is a flow chart to show an example of a method for manufacturing a glass gob. FIGS. 5 and 6 are schematic drawings (cross-sectional views) to explain the method for manufacturing a glass gob in this embodiment. FIG. 5 shows a state in step S12 to drop a molten glass droplet on the lower molding die, and FIG. 6 shows a state in step S13 to cool and solidify the molten glass droplet dropped on the lower molding die.

The lower molding die 10 shown in FIGS. 5 and 6 is an example of a lower molding die of this invention, and the cover layer 14 is arranged on the substrate 13 with the intermediate layer 12 therebetween. The portion of the surface 15 which contacts with the molten glass droplet 20 is subjected to a roughening process by etching. Therefore, it is possible to produce a glass gob without an air bubble at a low cost.

Further, the lower molding die 10 is configured so as to be heated at a predetermined temperature by a heating means not shown in the drawings. As for the heating means, those well known in the art may be used by appropriate selection. For example, a cartridge heater which is used by being buried in a member to heat, a sheet-form heater which is used by being brought in contact with a member to heat, an infrared heating system and a high frequency induction heating system, may be used.

Over the lower molding die 10, a melting bath 25 for storing molten glass 24, the lower part of which is equipped with dropping a nozzle 26, is arranged.

Steps will be explained in order according to the flow chart shown in FIG. 4.

First, the lower molding die 10 is heated at a predetermined temperature in advance (step S11). When the temperature of the lower molding die 10 is excessively low, there may be cases that a big wrinkle is generated on the bottom surface of a glass gob (the surface in contact with the lower molding die 10). or a crack is generated in a glass gob due to rapid cooling. On the contrary, when the temperature is unnecessarily high, there may be generated adhesion between the glass and the lower molding die 10 or the service life of the lower molding die 10 may be shortened, in addition, there may be a case that an air bubble remains in a glass gob due to adhesion of glass to the lower molding die 10. Since the suitable temperature depends on various conditions such as a type, form and size of glass, and a material and size of lower molding die 10, it is preferable to experimentally determine the suitable temperature in advance. Generally, it is preferably set to a temperature of approximately from Tg−100° C. to Tg+100° C. when glass transition temperature of glass is Tg.

Next, the molten glass droplet 20 is dropped on the lower molding die 10 (step S12). The melting bath 25 is heated by a heater not shown in the drawing, and the molten glass 24 is stored inside the melting bath 25. The bottom part of the melting bath 25 is equipped with a dropping nozzle 26, and the molten glass 24 passes by own weight through the flow path arranged inside the dropping nozzle 26 and stays at the tip portion by surface tension. When a certain mass of molten glass accumulate on the tip portion of dropping nozzle 26, it is naturally separated from the tip portion of the dropping nozzle 26, and a certain mass of molten glass droplet 20 falls downward (refer to FIG. 5).

Generally, the mass of the molten glass droplet 20 dropped is adjustable by an outer diameter of the tip portion of the dropping nozzle 26, and it is possible to drop a molten glass droplet of approximately 0.1-2 g although it depends on a type of glass. Further, the interval of dropping molten glass droplet 20 is adjustable by an inner diameter, length and heating temperature of the dropping nozzle 26. Therefore, by setting these conditions suitably, it is possible to drop a molten glass droplet having a desired mass at a desired interval.

The usable type of glass is not specifically limited and glass well known in the art can be used by appropriate selection. For example, optical glass such as borosilicate glass, silicate glass, phosphate glass and lanthanum type glass are listed.

Further, not only directly dropping a molten glass droplet on the lower molding die from dropping nozzle, a molten glass droplet having been dropped from the dropping nozzle may be once made to collide against a member having penetrating micro pores and a part of the molten glass droplet having collided may be dropped on the lower molding die as micro droplets through the penetrating micro pores. Thereby, manufacture of a further minute glass gob is possible. This method is described in detail in Japanese Laid-Open Patent Application Publication No. 2002-154834.

Next, the molten glass droplet 20 dropped is cool solidified on the lower molding die 10 (step S13) (refer to FIG. 6). The molten glass droplet 20 is cool-solidified by releasing heat to the lower molding die 10 or to the surrounding air. Since the surface 15 of the portion which contacts with the molten glass droplet 20 has been subjected to a predetermined roughening process, no air bubble generate in a solidified glass gob.

Thereafter, solidified glass was recovered (step S14) to complete manufacture of a glass gob. The recovery of a glass gob, for example, can be performed by use of such as a recovery apparatus well known in the art using vacuum adsorption. Further, in the case of successively performing manufacture of glass gob 27, processes to follow step S12 will be repeated. Lower molding die 10 is provided with high durability because deterioration of substrate 13 owing to such as an etching solution used at the time of a roughening process is prevented by intermediate layer 12. Therefore, the life of lower molding die 10 is very long in the case of repeating manufacture of glass gob 28, and it is possible to produce a glass gob without an air bubble at a low cost.

Herein, a glass gob manufactured by the manufacture method of this embodiment can be used for manufacture of various precision optical elements as a glass preform (gob preform) made by a reheat press method.

(Method for Manufacturing Glass Molded Article)

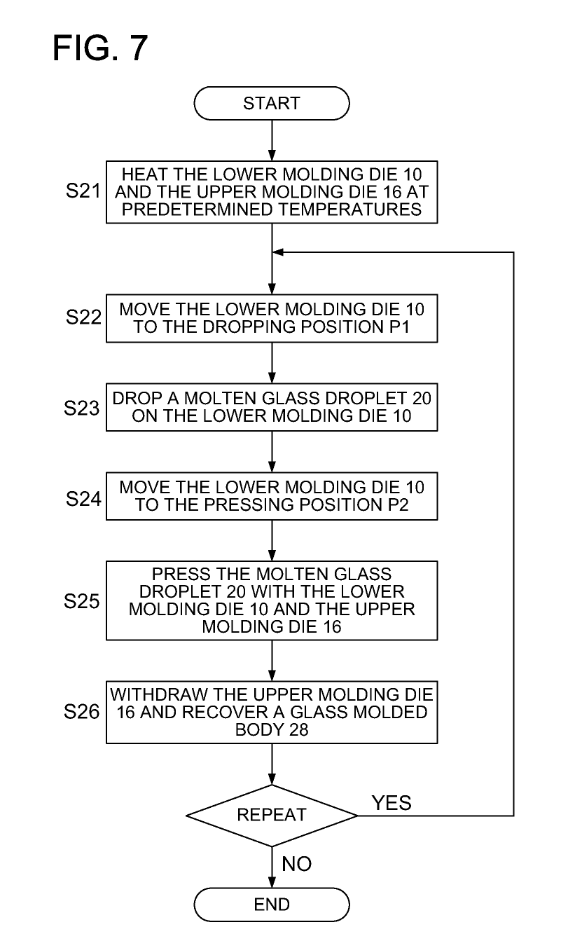

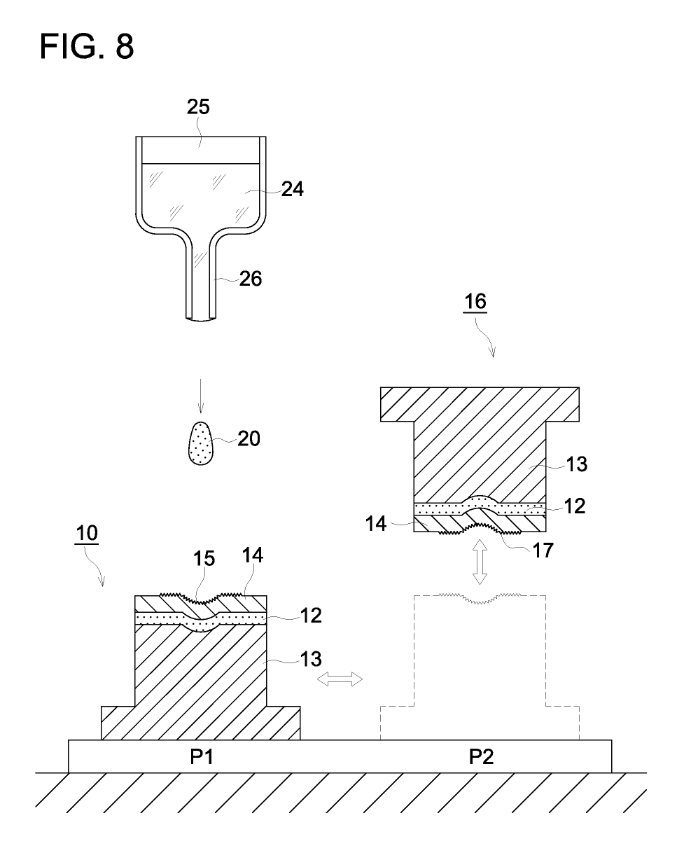

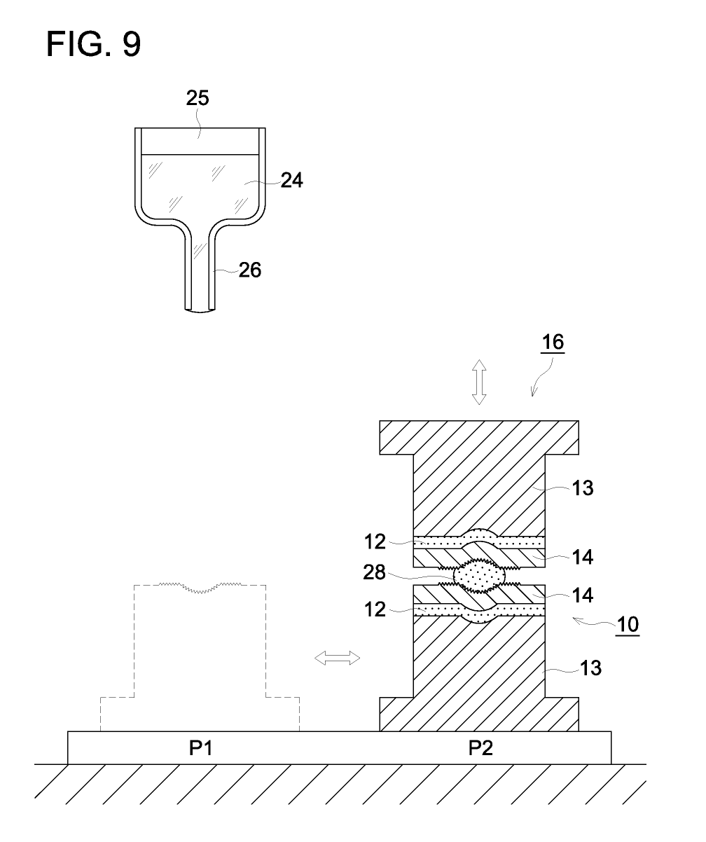

A method for manufacturing a glass molded article of this invention will be explained in reference to FIGS. 7-9. FIG. 7 is a flow chart to show an example of a method for manufacturing a glass gob. Further, FIGS. 8 and 9 are schematic drawings (cross-sectional views) to explain a method for manufacturing a glass molded article in this embodiment. FIG. 8 shows a state of the step (S23) to drop a molten glass droplet on a lower molding die, and FIG. 9 shows a state of the step (S25) to press a molten glass droplet with a lower molding die and an upper molding die, respectively.

The lower molding die 10 is the same as one explained in FIGS. 5 and 6. On the other hand, an upper molding die 16 is comprised of similar material to the lower molding die 10 and provided with a press plane 17 for pressing molten glass droplet 20. Different from the case of lower molding die 10, it is not necessarily to form intermediate layer 12 and cover layer 14 on substrate 13 of upper molding die 16 and to provide a roughening process on cover layer 14, in view of manufacturing a glass molded article without an air bubble.

However, in a liquid drop molding method such as this embodiment, glass and the upper molding die 16 are apt to adhere due to direct contact between the molten glass and the upper molding die 16, whereby a glass molded article may not be stably produced depending on conditions. Therefore, it is preferable to make the upper molding die 16, similarly to the lower molding die 10, to have a constitution in which an intermediate layer 12 and a cover layer 14 are provided on a substrate 13 and the surface of the cover layer 14 is subjected to a roughening process. Such an upper molding die 16 can effectively prevent adhesion with glass because of the surface having been subjected to a roughening process. Further, it is possible to minimize deterioration of the substrate 13 by a roughening process because of the intermediate layer 12 being provided.

By subjecting the surface of cover layer 14 of upper molding die 10 to a roughening process, an effect to prevent adhesion with glass is obtained; however, there is a case of insufficient effect to prevent adhesion when arithmetic average roughness Ra is less than 0.01 μm. On the contrary, there may be a case that the surface roughness of a glass molded article prepared is excessively large when arithmetic average roughness Ra is not less than 0.2 μm. Therefore, the surface 15 of the cover layer 14 of the upper molding die 16 is specifically preferably provided with an arithmetic average roughness Ra of not less than 0.01 μm and not more than 0.2 μm.

The lower molding die 10 is constituted so as to be movable between a position under the dropping nozzle 26 to receive molten glass droplet 20 (dropping position P1) and a position facing to the upper molding die 16 to press the molten glass droplet 20 (pressing position P2.), by a driving means not shown in the drawing. Further, the upper molding die 16 is constituted so as to be movable in the direction to press the molten glass droplet together with the lower molding die 10 (in the top-and-bottom direction in the drawing) by a driving means which is not shown in the drawing.

In the following, processes will be explained in order, according to the flow chart shown in FIG. 7.

First, the lower molding die 10 and the upper molding die 16 are heated at a predetermined temperature in advance (step S21). The lower molding die 10 and the upper molding die 16 are constituted so as to be heated at a predetermined temperature by a heating means which is not shown in the drawing. Preferable is a constitution which enables independent temperature control of the lower molding die 10 and the upper molding die 16. A predetermined temperature is the same as the case of step S11 of the method for manufacturing a glass gob which was described above, and a temperature capable of forming a satisfactory transfer surface on a glass molded article by press-molding may be appropriately selected. The heating temperatures of the lower molding die 10 and of the upper molding die 16 may be the same or different from each other.

Next, the lower molding die 10 is moved to the dropping position P1 (step S22) and the molten glass droplet 20 is dropped through the dropping nozzle 26 (step S23) (refer to FIG. 8). The conditions at the time of dropping molten glass droplet 20 are similar to the case of step S12 of the method for manufacturing a glass gob described above.

Next, the lower molding die 10 is moved to the pressing position P2 (step S24) and the upper molding die 16 is moved downward, whereby the molten glass droplet 20 is pressed with the lower molding die 10 and the upper molding die 16 (step S25) (refer to FIG. 9). The molten glass droplet 20 is cool-solidified, by heat release through the contact surfaces with the lower molding die 10 and the upper molding die 16 during pressing. After cooling to a temperature at which the shape of a transfer surface formed on a glass molded article will not deform even when pressing is released. The temperature depends on a type of glass; size, shape and required precision of a glass molded article and the like; however, generally cooling may be performed down to a temperature near Tg of the glass.

The load to be applied for pressing the molten glass droplet 20 may be always constant or may be varied with time. The magnitude of the load to be applied may be appropriately set depending on a size of the glass molded article to be manufactured. Further, a driving means to move the upper molding die 16 is not specifically limited, and the driving means well known in the art an air cylinder, an oil cylinder, an electric cylinder using a servo motor and the like may be employed by being appropriately selected.

The upper molding die 16 is withdrawn upward and the glass molded article 28 having been solidified is recovered, whereby the manufacture of a glass molded article is completed. Since the surface 15 of the lower molding die 10 has been subjected to a predetermined roughening process, no air bubble generate in a prepared glass molded article. Thereafter, in the case of successively performing the manufacture of a glass molded article, lower molding die 10 is moved again to the dropping position P1 (step S22) and processes to follow are repeated.

Herein, the method for manufacturing a glass molded article of this invention may includes processes other than those explained here. For example, may be included is a process to inspect the shape of the glass molded article before recovering it, or a process to clean the lower molding die 10 and the upper molding die 16 after recovering the glass molded article.

A glass molded article manufactured by the manufacture method of this invention can be used as various optical elements such as an image taking lens far a digital camera, an optical pickup lens for a DVD and a coupling lens for optical communication. Further, it can be also used as a glass preform for a reheat press method

### EXAMPLES

In the following, examples performed to confirm the advantages of this invention will be explained; however, this invention is not limited thereto.

### Examples 1-4

Manufacture of a glass molded article was performed according to a flow chart shown in FIG. 7. The outer diameter of a glass molded article to be manufactured was set to 7 mm and the thickness at the central portion to 3.5 mm.

First, four types of the lower molding dies 10 (examples 1-4) were prepared as shown in table 1. As the substrate 13, a super hard material comprising tungsten carbide as a primary component was used. After the materials described in table 1 had been deposited as the intermediate layer 12, a metallic film made of chromium as the cover layer 14 was deposited. The thickness of the intermediate layer 12 was set to 0.3 μm and the thickness of a cover layer to 0.5 μm, and each layer was deposited by a spattering method.

After the cover layer 14 was deposited, the surface 15 of the cover layer 14 was subjected to a roughening process by being immersed in an etching solution. As the etching solution, a chromium etching solution (ECR-2, manufactured by Nacalai Tesque Co., Ltd.), which contains ammonium ceric nitrate and is available on the market, was used.

The etching time was adjusted so as to make the arithmetic average roughness Ra of the surface 15 of the cover layer 14 after etching to be 0.01 μm (example 1), 0.1 μm (example 2), 0.2 μm (example 3), and 0.25 μm (example 4). At this time, each average length RSm of a roughness curvilinear element was 0.03 μm (example 1), 025 μm (example 2), 0.4 μm (example 3), and 0.5 μm (example 4). Herein, arithmetic average roughness Ra and average length RSm of a roughness curvilinear element were measured by use of an AFM (D3100, manufactured by Digital Instruments).

The manufacture of glass molded articles was performed by use of these 4 types of the lower molding dies 10 according to the flow chart shown in FIG. 7. As glass material, phosphate type glass having Tg of 480° C. was used. The heating temperatures in step S21 were set to 500° C. for the lower molding die 10 and 450° C. for the upper molding die 16. The temperature in the neighborhood of the top of dropping nozzle 26 was set to 1,000° C. so that approximately 190 mg of molten glass droplet 20 will drop. The load at the time of pressing was 1,800 N. Herein, as the upper molding die 16, one in which the intermediate layer 12 and the cover layer 14 were formed similarly to the lower molding die 10 and the cover layer 14 had been subjected to a roughening process was used. The deposition conditions and roughening conditions for the upper molding die 16 were the same as those employed in example 2.

With respect to the glass molded articles manufactured by use of respective lower molding dies 10 of examples 1-4, generation of an air bubble was evaluated by microscopic observation. Further, arithmetic average roughness Ra of the bottom surface (the surface formed by contacting with the bottom surface of the lower molding die 10) of the glass molded article was measured. As for arithmetic average roughness Ra of the bottom surface of the glass molded article, the case of not more than 0.1 νm was ranked to be the best (A), the case of more than 0.1 μm and not more than 0.15 μm was ranked to be good (B), and the case of more than 0.15 μm and not more than 0.2 μm was ranked fair (C).

Further, based on the evaluation of an air bubble and arithmetic average roughness Ra on the bottom surface, performance evaluation of a glass molded article was made. As for performance evaluation, the case without an air bubble and evaluation of Ra being A was ranked to be the best (A), the case without an air bubble and evaluation of Ra being B was ranked to be good (B), and the case with an air bubble was ranked to be bad (D).

Further, molding of a glass molded article was repeated to investigate what number of molding were performed until film peeling of cover layer 14 was generated, whereby durability of the lower molding die was evaluated. As for the evaluation of durability, the case of no generation of film peeling until molding of 30,000 times was ranked to be good (A) and the case of generation of film peeling at molding of less than 30,000 times was ranked to be problematic (D). These evaluation results are summarized in table 1.

TABLE 1

| | | | | Glass molded body | | | Durability of lower die | |
|---|---|---|---|---|---|---|---|---|
| | Coating layer 14 | | Intermediate | Air | Ra of bottom | Capability | Times when film | |
| | Ra (μm) | RSm (μm) | layer 12 | bubbles | surface | evaluation | peeling generated | Evaluation |
| Example 1 | 0.01 | 0.03 | Ti | none | A | A | no film peeling | B |
| Example 2 | 0.1 | 0.25 | TiC | none | A | A | no film peeling | B |
| Example 3 | 0.2 | 0.4 | TiN | none | A | A | no film peeling | B |
| Example 4 | 0.25 | 0.5 | Ti | none | B | B | no film peeling | B |
| Comparative | 0.01 | 0.03 | none | none | A | A | 8,600 times | D |
| example 1 | | | | | | | | |
| Comparative | 0.1 | 0.25 | none | none | A | A | 4700 times | D |
| example 2 | | | | | | | | |
| Comparative | 0.2 | 0.4 | none | none | A | A | 3400 times | D |
| example 3 | | | | | | | | |
| Comparative | 0.25 | 0.5 | none | none | B | B | 1500 times | D |
| example 4 | | | | | | | | |
| Comparative | 0.005 | 0.01 | TiC | generated (D) | A | D | — | — |
| example 5 | | | | | | | | |
| Comparative | 0.3 | 0.6 | TiN | generated (D) | C | D | — | — |
| example 6 | | | | | | | | |

In any case of examples 1-4, there was no generation of an air bubble in the glass molded article and the performance evaluation rank of the glass molded article was A or B. Further, there was no occurrence of film peeling even after 30,000 times of molding, and excellent durability was confirmed. Further, it has been confirmed that in the case of the arithmetic average roughness Ra of the cover layer 14 being not more than 0.2 μm (examples 1-3), the arithmetic average roughness Ra of the bottom surface of a glass molded article is 0.1 μm and the performance evaluation is the best (A).

### Comparative Examples 1-4

In a similar manner to examples 1-4, the molding and the evaluation of glass molded articles were performed by use of 4 types of the lower molding dies 10 in which etching time was varied Herein, different from examples 1-4, the cover layer was formed directly on the substrate 13 without providing the intermediate layer 12. The evaluation results are summarized also in table 1.

In any case of comparative examples 1-4, although no air bubble was generated in the glass molded article, film peeling of cover layer 14 was generated at molding of less than 10,000 times, and the durability of the lower molding die was proven to be insufficient.

### Comparative Examples 5 and 6

In a similar manner to examples 1-4, the molding and the evaluation of glass molded articles were performed by use of 2 types of the lower molding dies 10 in which etching time was varied. The arithmetic average roughness Ra of the surface 15 of the cover layer 14 was 0.005 μm (comparative example 5) and 0.3 μm (comparative example 6), and he average length RSm of a roughness curvilinear element was 0.01 μm (comparative example 5) and 0.6 μm (comparative example 6), respectively. The evaluation results are summarized also in table 1.

In each of comparative example 5 and comparative example 6, it has been confirmed that an air bubble was generated (performance evaluation: D) and a satisfactory glass molded article was not prepared. Herein, the test for durability evaluation was omitted.

1. A lower molding die for receiving a dropped molten glass droplet, the lower molding die comprising:
a substrate;
an intermediate layer formed on the substrate; and
a cover layer formed on the intermediate layer,
wherein a surface of the cover layer has been subjected to a roughening process for increasing an arithmetic average roughness Ra, and the surface of the cover layer has the arithmetic average roughness Ra of 0.01 μm or more and an average length RSm of a roughness curvilinear element of 0.5 μm or less.

2. The lower molding die of claim 1, wherein the surface of the cover layer has an arithmetic average roughness Ra of 0.2 μm or less.

3. The lower molding die of claim 1, wherein the intermediate layer includes at least one of metallic titanium, titanium carbide and titanium nitride.

4. The lower molding die of claim 1, wherein the intermediate layer has a thickness of 0.03 μm or more and 2 μm or less.

5. A method for manufacturing a lower molding die for receiving a dropped molten glass droplet, the method comprising the steps of:
forming an intermediate layer on a substrate;
forming a cover layer on the intermediate layer;
performing a roughening process on a surface of the cover layer to increase an arithmetic average roughness Ra,
wherein the surface of the cover layer having been subjected to the roughening process has an arithmetic average roughness Ra of 0.01 μm or more and an average length RSm of a roughness curvilinear element of 0.05 μm or less.

6. A method for manufacturing a glass gob, the method comprising the steps of:
dropping a molten glass droplet on a lower molding die; and
cool-solidifying the dropped molten glass droplet on the lower molding die,
wherein the lower molding die is a molding die of claim 1.

7. A method for manufacturing a glass molded article, the method comprising the steps of:
dropping a molten glass droplet on a lower molding die; and
press-molding the dropped molten glass droplet with the lower molding die and an upper molding die facing the lower molding die,
wherein the lower molding die is a lower molding die of claim 1.

8. The method of claim 7 for manufacturing a glass molded article, wherein the upper molding die includes:
a substrate;
an intermediate layer formed on the substrate; and
a cover layer formed on the intermediate layer,
wherein a surface of the cover layer has been subjected to a roughening process for increasing an arithmetic average roughness Ra.

9. The method of claim 8 for manufacturing a glass molded article, wherein the surface of the cover layer of the upper molding die has an arithmetic average roughness Ra of 0.01 μm or more and 0.2 μm or less.
